(19) United States
(12) Patent Application Publication
(10) Pub. No.: US 2004/0110918 A1
(43) Pub. Date: Jun. 10, 2004

(54) Process for producing polyaddition compounds containing uretdione groups

(76) Inventors: Hans-Josef Laas, Koln (DE); Oswald Wilmes, Koln (DE); Hans-Ulrich Meier-Westhues, Leverkusen (DE); Martin Ullrich, Leverkusen (DE); Konrad Fischer, Odenthal (DE); Ulrich Freudenberg, Pulheim (DE)

Correspondence Address: BAYER POLYMERS LLC, 100 BAYER ROAD, PITTSBURGH, PA, 15205, US

(21) Appl. No.: 10/724,990

(22) Filed: Dec. 1, 2003

Related U.S. Application Data
(63) Continuation of application No. 09/598,423, filed on Jun. 20, 2000, now abandoned.

(30) Foreign Application Priority Data
Jun. 25, 1999 (DE) 19929064.4

(51) Int. Cl. C08G 18/28; C08G 18/77

(52) U.S. Cl. 528/73

(57) ABSTRACT

The present invention relates to a process for producing uretdione group-containing polyaddition products, which are solid below 40° C. and liquid above 125° C., by reacting in a static mixer

A) a uretdione group-containing polyisocyanates with an average isocyanate functionality of at least 2.0, and

B) up to 70 wt. %, based on the total weight of components A) and B), of a diisocyanate other than A), with

C) a polyol having a number average molecular weight of 62-2000 and an average functionality of at least 2.0, and

D) up to 40 wt. %, based on the total weight of components C) and D), of a monofunctional isocyanate-reactive compound,

at an equivalent ratio of isocyanate groups to isocyanates-reactive groups of 1.8:1 to 0.6:1.

### FIELD OF THE INVENTION

The present invention relates to a novel process for solvent-free production of polyaddition compounds containing uretdione groups.

### BACKGROUND OF THE INVENTION

Polyaddition compounds containing uretdione groups are currently being increasingly used as blocking agent-free crosslinkers for highly weather-resistant polyurethane (PU) powder coating compositions. The crosslinking mechanism used with these compounds involves thermal dissociation of the uretdione groups into free isocyanate groups and subsequent reaction thereof with a hydroxy-functional binder.

The production of uretdione powder coating crosslinkers is known. DE-A 2,420,475 describes the use of reaction products of uretdione group-containing polyisocyanates or polyisocyanate mixtures with difunctional and optionally monofunctional aliphatic or cycloaliphatic compounds carrying isocyanate-reactive groups as blocking group-free crosslinking agents for PU stoving systems. Solid products suitable for use as powder coating hardeners having melting points of 140 to 260° C., can be obtained by reaction of uretdione group-containing polyisocyanates in particular those prepared from aromatic diisocyanates, such as toluene diisocyanate (TDI), with simple diols, optionally containing ether groups.

However, dissociation of the uretdione ring in the presence of hydroxy-functional reactants begins to a noticeable degree at temperatures as low as approximately 110° C. Therefore, the above-described polyaddition products may not be produced solvent-free in the melt, but only in solution in solvents which are inert to isocyanates. This necessitates an additional process step for separating the auxiliary solvent.

Uretdione group-containing powder coating crosslinking agents, prepared from the linear, difunctional uretdione of 1-isocyanato-3,3,5-trimethyl-5-isocyanatomethyl-cyclohexane (IPDI), simple diols, optionally containing ether groups, and, optionally in the terminal position, monoamines or monoalcohols, are known from EP-A 0,045,994, EP-A 0,045,996 and EP-A 0,045,998. During the production of these polyaddition products, a reaction temperature of 110° C. must not be exceeded, since otherwise dissociation of the uretdione groups occurs. However, sometimes polyaddition compounds are obtained, which have melting points of the order of this dissociation temperature or even higher, in particular where there is a high degree of extension, i.e. if at least 70% of the NCO groups of the difunctional IPDI uretdione are reacted with diols with chain extension. This extension is necessary to ensure high uretdione functionality and thus a high crosslinking density. Such polyaddition compounds may therefore only be reliably and reproducibly produced in solution with a subsequent evaporation step.

However, the IPDI uretdione powder coating hardeners described in the above-mentioned publications which have melting points distinctly below the dissociation temperature (approximately 80° C.) still exhibit high melt viscosities at the maximum permitted reaction temperature of 110° C. Their melt production is barely possible on an industrial scale because of inadequate stirrability.

Uretdione powder coating crosslinking agents produced in a solvent-free manner have been described in EP-A 639,598. This application relates to special poly-addition compounds which are produced using chain extending agents containing ester and/or carbonate groups and which are distinguished by particularly low melt viscosities. Similarly low viscosities are also exhibited by the dimer diol-modified uretdione crosslinking agents described in EP-A 720,994, which may also be readily stirred in the melt at temperatures only slightly above their melting point. Solvent-free production of the crosslinking agents described in these two publications may be carried out up to a scale of several hundred kilograms without the free NCO group content increasing excessively. In the case of larger production batches, however, the thermal liability of the uretdione groups becomes disadvantageously noticeable, if longer times are necessary for discharging the product melt from the reactor. As the residence time in the reaction vessel increases, the NCO content within individual production batches rises continuously, while at the same time the related reduction in molecular weight leads to a constant decrease in glass transition temperature. For this reason, the uretdione crosslinking agents described in EP-A 639,598 or EP-A 720,994 can be obtained on an economically viable scale only with variable quality.

Another solvent-free production process for uretdione powder coating crosslinking agents is known from EP-A 669,353, 669,354, 780,417 and 825,214. These publications describe the continuous reaction of uretdione polyisocyanates with (polyester) diols or polyols and optionally monoalcohols in special intensive kneaders, for example twin-screw extruders, at extreme temperatures for uretdione groups of up to 190° C. Since urethanization proceeds very rapidly at this temperature, the residence time of the product melt in the reaction screw may be selected to be so short that uretdione cleavage is negligible. In this manner, products are obtained having a constant quality with a high uretdione content and a small proportion of free isocyanate groups. A disadvantage of this process, however, is the very high costs required for suitable extruders and the comparatively high operating and maintenance costs.

It is an object of the present invention to provide a novel process for producing polyaddition products containing uretdione groups, which does not exhibit the above-mentioned disadvantages of the prior art. It is a further object of the invention that the novel process should allow solvent-free production, in a simple manner, of uretdione powder coating crosslinking agents having constant quality, without the need for complex and expensive mixing units.

This object may be achieved with the process according to the invention described in more detail below. The process according to the invention is based on the surprising observation that, despite the fact that their melt viscosity is sometimes very high, blocking agent-free uretdione powder coating crosslinkers may be produced without solvent, i.e. in the melt, in simple static mixers, without any noticeable dissociation of uretdione groups. This was all the more surprising since continuous solvent-free production of blocked polyurethane powder coating crosslinking agents was known from EP-A 669,355, in which it proved possible to produce in static mixers only products which exhibit melt viscosities of ≦150,000 mPa.s, preferably ≦100,000 mPa.s and in particular ≦50,000 mPa.s at 130° C., while more highly viscous product melts may only be processed in intensive kneaders.

Therefore, the person skilled in the art could not assume that thermally labile polyaddition compounds, which contain uretdione groups and are suitable for use as powder coating crosslinking agents and which generally exhibit viscosities of 400,000 mPa.s or more at a temperature of 130° C., could be produced without solvent and without noticeable dissociation in simple static mixers. Instead, the obvious assumption would be that, in accordance with the teaching of EP-A 669 354, continuous solvent-free production of such high-viscosity products is only possible in intensive kneaders with the action of considerable shear forces.

### SUMMARY OF THE INVENTION

The present invention relates to a process for producing uretdione group-containing polyaddition products, which are solid below 40° C. and liquid above 125° C., by reacting in a static mixer

A) a uretdione group-containing polyisocyanates with an average isocyanate functionality of at least 2.0, and

B) up to 70 wt. %, based on the total weight of components A) and B), of a diisocyanate other than A), with

C) a polyol having a number average molecular weight of 62-2000 and an average functionality of at least 2.0, and

D) up to 40 wt. %, based on the total weight of components C) and D), of a monofunctional isocyanate-reactive compound,

at an equivalent ratio of isocyanate groups to isocyanates-reactive groups of 1.8:1 to 0.6:1.

### DETAILED DESCRIPTION OF THE INVENTION

Starting compounds A) for the process according to the invention include any uretdione group-containing polyisocyanates having an average isocyanate functionality of at least 2.0, which may be obtained in a known manner by catalytic dimerization of a portion of the isocyanate groups of monomeric diisocyanates and preferably subsequent separation of the unreacted monomeric diisocyanate excess, for example by thin-film distillation. To produce starting compounds A), any diisocyanates are suitable which have aliphatically, cycloaliphatically, araliphatically and/or aromatically bound isocyanate groups, for example those with molecular weights of 140 to 400. Examples include 1,4-diisocyanato-butane,1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanato-cyclohexane, 1,3- and 1,4-bis-(isocyanatomethyl)cyclohexane, 1,3-diisocyanato-2(4)-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 4,4′-diisocyanato-dicyclohexylmethane, bis-(isocyanatomethyl)norbomane, 1,3- and 1,4-phenylene diisocyanate, 2,4- and/or 2,6-tolylene diisocyanate, diphenyl-methane-2,4′- and/or -4,4′-diisocyanate, naphthylene-1,5-diisocyanate and mixtures of these diisocyanates.

Suitable catalysts for producing starting compounds A) from the above-mentioned diisocyanates include all known compounds which catalyze dimerization of isocyanate groups. Examples include the tertiary organic phosphines mentioned in U.S. Pat. No. 4,614,785, column 4, lines 11 to 47, or DE-A 1,934,763 and 3,900,053; the tris-(dialkylamino)phosphines mentioned in DE-A 3,030,513, DE-A 3,227,779 and DE-A 3,437,635; the substituted pyridines mentioned in DE-A 1,081,895 and DE-A 3,739,549; and the substituted imidazoles or benzimidazoles mentioned in EP-A 417,603.

Preferred starting compounds A) for the process according to the invention are uretdione group-containing polyisocyanates prepared from diisocyanates with aliphatically and/or cycloaliphatically bound isocyanate and mixtures of such polyisocyanates.

The use of uretdione group-containing polyisocyanates prepared from HDI and/or IPDI is particular preferred.

During the known production of polyisocyanates containing uretdione groups by catalytic dimerization of the diisocyanates mentioned by way of example, a trimerization reaction frequently occurs at the same time as the dimerization reaction but to a lesser degree, forming higher than difunctional polyisocyanates containing isocyanurate groups. Accordingly, the average NCO functionality of component A), based on the free NCO groups, is preferably 2.0 to 2.5.

Other diisocyanates B) may optionally also be used in the process according to the invention. Examples include the above-described diisocyanates suitable for producing the starting compounds A), said diisocyanates having aliphatically, cycloaliphatically, araliphatically and/or aromatically bound isocyanate groups.

These diisocyanates B) are used, if at all, in amounts of up to 70 wt. %, preferably up to 50 wt. %, based on the total weight of components A) and B). Mixtures of starting components A) and B) suitable for the process according to the invention also include solutions of uretdione group-containing polyisocyanates in monomeric diisocyanates. They are obtained during the above-described production of the starting compounds A) if the excess unreacted diisocyanates are not removed after a partial catalytic dimerization has occurred. In this instance, the portion of diisocyanates B) in the total amount of starting components A) and B) may also amount to up to 70 wt. %. Preferred diisocyanates B) include diisocyanates with cycloaliphatically bound isocyanate groups. The use of IPDI and/or 4,4′-diisocyanatodicyclohexyl-methane is particularly preferred.

Starting compounds C) for the process according to the invention include any polyols having molecular weights of 62-2000, and an average OH functionality of at least 2.0 or mixtures of such polyols.

Suitable polyols C) include, for example, polyhydric alcohols with molecular weights of 62 to 400. Examples include 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol or 4,4′-(1-methy-lethylidene)-biscyclohexanol, 1,2,3-propanetriol, 1,1,1 -trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate. Other suitable polyols C) include ester or ether alcohols, such as hydroxypivalic acid neopentyl glycol ester, diethylene glycol, and dipropylene glycol.

Other suitable compounds C) include polyester, polycarbonate, polyester carbonate and polyether polyols.

Polyester polyols include those having an number-average molecular weight (calculated from the functionality and OH number) of 134 to 2000, preferably 250 to 1500, and having a hydroxyl group content of 1 to 21 wt. %, preferably 2 to 18 wt. %. They may be produced in known manner by reacting polyhydric alcohols, for example the above-mentioned having molecular weights of 62 to 400, with sub-stoichiometric amounts of polybasic carboxylic acids, the corresponding carboxylic anhydrides, the corresponding polycarboxylic acid esters of lower alcohols or lactones.

The acids or acid derivatives used to produce the polyester polyols may be aliphatic, cycloaliphatic and/or aromatic and optionally substituted, e.g. by halogen atoms, and/or unsaturated. Examples of suitable acids include polybasic carboxylic acids with molecular weights of 118 to 300 or derivatives thereof, such as succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, terephthalic acid dimethyl esters and terephthalic acid bis-glycol esters.

To produce the polyester polyols, it is also possible to use any mixtures of these starting compounds .

One type of polyester polyol preferably used includes those which may be produced in a known manner from lactones and said polyhydric alcohols as starter molecules with ring opening. Lactones suitable for producing these polyester polyols include β-propiolactone, γ-butyrolactone, γ- and δ-valerolactone, ε-caprolactone, 3,5,5- and 3,3,5-trimethyl caprolactone and mixtures of such lactones.

Polycarbonate polyols include the known polycarbonate diols prepared for example by reaction of dihydric alcohols, for example those mentioned above in the list of polyhydric alcohols having molecular weights of 62 to 400, with phosgene or diaryl carbonates, for example diphenyl carbonate.

Polyester carbonate polyols include, the known diols containing ester groups and carbonate groups, prepared, for example, in accordance with the teaching of DE-A 1,770,245 by reacting dihydric alcohols with lactones mentioned above, in particular ε-caprolactone, and then reacting the resulting polyester diols with diphenyl carbonate.

Polyether polyols include those of an number-average molecular weight, calculable from the functionality and OH number, of 200 to 2000, preferably 250 to 1500, and having a hydroxyl group content of 1.7 to 25 wt. %, preferably 2.2 to 20 wt. %. They may be obtained by alkoxylation of suitable starter molecules. To produce these polyether polyols, any polyhydric alcohols, such as those described above having molecular weights of 62 to 400, may be used as starter molecules. Alkylene oxides suitable for the alkoxylation reaction are in particular ethylene oxide and propylene oxide, which may be used in the alkoxylation reaction in any sequence or also as a mixture.

Polyoxytetramethylene glycols, obtained, for example in accordance with Angew. Chem 72, 927 (1960) by polymerization of tetrahydrofuran, are also suitable polyether polyols.

Also suitable as compounds C) are dimer diols, which may be produced in a known manner by hydration of dimeric fatty acids and/or the esters thereof in accordance with DE-A 1,768,313 or the processes described in EP-A 720,994, page 4, lines 33 to 58.

Preferred compounds C) for the process according to the invention are the above-mentioned polyhydric alcohols with molecular weights of 62 to 400, the above-mentioned polyester or polycarbonate polyols together with any mixtures of these polyol components.

More preferably, diols with molecular weights of 62 to 300 or polyester diols or polycarbonate diols with molecular weights of 134 to 1200 or mixtures thereof are used.

Most preferred compounds C) for the process according to the invention are mixtures of the above-mentioned polyester diols having up to 80 wt. %, preferably up to 60 wt. %, based on the total weight of the polyols C) used, and of diols with molecular weights of 62 to 300.

In the process according to the invention it is also possible to use other mono-functional compounds D) which are reactive with isocyanate groups. These include in particular primary aliphatic or cycloaliphatic monoamines, such as methylamine, ethylamine, n-propylamine, isopropylamine, isomeric butylamines, pentylamines, hexylamines and octylamines, n-dodecylamine, n-tetradecylamine, n-hexadecylamine, n-octadecylamine, cyclohexylamine, isomeric methylcyclohexylamines and aminomethylcyclohexane; secondary monoamines, such as dimethylamine, diethylamine, dipropylamine, diisopropylamine, dibutylamine, diisobutylamine, bis(2-ethylhexyl)amine, N-methyl- and N-ethylcyclohexylamine and dicyclohexylamine; and monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, isomeric methylcyclohexanols and hydroxymethyl-cyclohexane.

These monofunctional compounds D) are used, if at all, in amounts of up to 40 wt. %, preferably up to 25 wt. %, based on the total amount of starting compounds C) and D).

Preferred starting compounds D) for the process according to the invention are the aliphatic or cycloaliphatic monoalcohols of the above-mentioned type.

In the process according to the invention, the uretdione group-containing polyisocyanates A), optionally together with diisocyanates B), are reacted with the polyols C) and optionally isocyanate-reactive monofunctional compounds D) at the equivalent ratio of isocyanate groups to isocyanate-reactive groups of 1.8:1 to 0.6:1, preferably 1.6:1 to 0.8:1.

The starting compounds are continuously metered into a static mixer, in appropriate amounts by means of suitable commercially available pumps, in particular low-surge piston, diaphragm or gear pumps. The starting compounds may be optionally preheated to temperatures of up to 120° C., preferably up to 90° C. The addition may be performed using separate streams of starting compounds (educts), but if more than two starting compounds are used it may be advantageous to combine several educts, for example, the isocyanate-functional starting compounds A) and optionally B) and/or the starting compounds C) and optionally D) respectively into single educt streams.

Further additives may optionally be added to the starting compounds. To accelerate the polyaddition reaction, it is also possible to use the known catalysts from polyurethane chemistry. Examples include tert. amines such as triethylamine, pyridine, methylpyridine, benzyl-dimethylamine, N,N-endoethylene piperazine, N-methylpiperidine, pentamethyldiethylene triamine, N,N-dimethylaminocyclohexane, and N,N′-dimethylpiperazine; and metal salts such as iron(III) chloride, zinc chloride, zinc-2-ethylcaproate, tin(II) octanoate, tin(II) ethylcaproate, dibutyltin(IV) dilaurate and molybdenum glycolate.

These catalysts are optionally used in amounts of 0.001 to 2.0 wt. %, preferably 0.01 to 0.5 wt. %, based on the total amount of starting compounds.

Other additives include the known flow control agents known from powder coating technology, such as polybutyl acrylate or others prepared from polysilicones; light stabilizers, sterically hindered amines; UV absorbers, including benzotriazoles or benzophenones; and color stabilizers protecting against the risk of yellowing due to overstoving, trialkyl, triaryl and/or trisalkylphenyl phosphites optionally containing inert substituents.

According to the invention, reaction of the starting compounds is performed in a static mixer, i.e. in an optionally temperature-controllable tubular reactor equipped with suitable inserts for homogenizing liquids. Static mixing elements of various structures may be used as tubular reactor inserts, and may optionally also be arranged one after the other in any sequence. Suitable types of static mixing elements include the known twisted sheet metal elements (Kenics mixer), metallic cloth packing, such as in SMX, SMXL or SMR mixers made by Sulzer (Winterthur, Switzerland) or any other mixer types, such as those described in Chem.-Ing-Tech. 52 (1980) 285-291. The known SMX and/or SMXL mixers are preferably used.

The static mixer used in the process according to the invention is preferably composed of various zones, the temperature of which may optionally be separately controlled, and preferably consists of at least one mixing zone, in which the individual educt streams meet and are intimately mixed within a short period, together with a subsequent reaction zone, in which the polyaddition reaction occurs. In order to adjust the residence times to be maintained in the respective zones to a desired throughput, the length and diameter of the mixing elements installed are specially adapted to the relevant process steps.

The dimensions of the static mixing elements and the reactor diameter in the mixing zone should allow the residence time of the starting components to be 0.1 to 30 seconds, preferably 0.5 to 20 seconds, and more preferably 1 to 10 seconds. The mixing elements are constructed such that even this short time is sufficient to ensure problem-free homogeneous mixing of the educts, before the urethanization reaction begins. The mixing zone may optionally be temperature-controlled, wherein the temperature to which it is heated may be up to 140° C., preferably up to 125° C. and more preferably to up to 110° C.

The temperature of the subsequent reaction zone has to be controlled that the product melt remains flowable at all times, i.e. exhibits a temperature higher than 125° C., preferably 125 to 200° C. and more preferably 130 to 180° C. Taking into account the exothermic nature of the urethanization reaction, heating temperatures of 60 to 180° C., preferably 70 to 160° C., and more preferably 80 to 140° C. are generally sufficient for this purpose. The static mixing elements and the reactor diameter are constructed in the reaction zone so that the residence time of the reaction melt is 0.5 to 30 minutes, preferably 1 to 15 minutes and more preferably 2 to 10 minutes. After this period, the reaction is generally complete.

After leaving the reaction zone, the product melt is cooled as quickly as possible, for example by means of a chill belt, and the uretdione group-containing product is formulated by conventional methods known from powder coating technology. For example, it is made into flakes or tablets.

Due to the short residence time, (short exposure to elevated temperatures) in the static mixer, only minimal uretdione cleavage occurs in the process according to the invention. Depending on the equivalent ratio of isocyanate groups to isocyanate-reactive groups, polyaddition compounds containing uretdione groups are obtained which have:

an average isocyanate functionality of 1.8 to 8.0, preferably 2.0 to 6.0, and more preferably 2.0 to 5.0;

a content of free isocyanate groups of 0 to 6.0 wt. %, preferably 0 to 5.0 wt. %, and more preferably 0 to 4.0 wt. %;

a content of uretdione groups of 3 to 19 wt. %, preferably 5 to 17 wt. %, and more preferably 7 to 17 wt. %,

and are solid below 40° C. and liquid above 125° C. and preferably exhibit a melting point or melting range, determined by differential thermal analysis (DTA), which lies within a temperature range of 40 to 110° C., and more preferably within a temperature range of 50 to 100° C.

The process according to the invention allows solvent-free production of uretdione group-containing polyaddition compounds in a very simple manner and in cost-effective installations entailing low energy, maintenance and repair costs. It is even possible to produce such products with a constant quality, which cannot be obtained by discontinuous processes because of too high a melt, viscosity and the lack of stirrability connected therewith.

The uretdione group-containing polyaddition compounds which may be obtained by the process according to the invention represent high-grade starting materials for the production of polyurethane plastics by the isocyanate polyaddition process. They are used in particular as crosslinking components in heat-curable, blocking agent-free PU powder coating compositions.

The invention is further illustrated but is not intended to be limited by the following examples in which all parts and percentages are by weight unless otherwise specified.

### EXAMPLES

### Example 1

A static mixer was used which contains double-walled jacket heating and contains a mixing zone and a reaction zone with a total volume of 180 ml. The mixing element in the mixing zone was an SMX 6 mixer made by Sulzer (Winterthur, Switzerland) with a diameter of 6 mm and a length of 60.5 mm, while the mixing element in the reaction zone was an SMXL 20 mixer made by Sulzer with a diameter of 20 mm and a length of 520 mm.

Metering of the educts was performed with the aid of a two-headed piston metering pump EK2 made by Lewa (Leonberg) and specially equipped for use with static mixers, the two pump heads discharging at the same time.

1435 g (6.0 eq.) per hour of a uretdione group-containing polyisocyanate prepared from 1-isocyanato-3,3,5-trimethyl-5-isocyanato-methyl-cyclohexahe (IPDI) and having a free isocyanate group content of 17.5%, an average NCO functionality of 2.0 and a uretdione group content (determined by hot titration) of 20.2% were metered continuously under dry nitrogen and heated to a temperature of 80° C. from a receiver flask A to the mixing zone of the static mixer. The tubes between the receiver A and the pump or pump and static mixer together with the relevant pump head were heated to a temperature of 98 to 102° C.

At the same time, 720 g (6.0 eq.) per hour of a mixture of 85.6 parts by weight of a polyester diol prepared from 1,4-butanediol and ε-caprolactone and having an OH value of 427 mg KOH/g, 3.6 parts by weight of 1,4 butanediol, 10.6 parts by weight 2-ethyl-1-hexanol and 0.2 parts by weight dibutyltin(IV) dilaurate (DBTL) as catalyst, were metered from a further receiver B to the mixing zone. Heating of receiver, tubes and pump head was not required in this instance, due to the low viscosity of the polyol mixture.

The static mixer was heated over its whole length to a jacket temperature of 108 to 112° C. The average residence time of the reaction melt amounted to 5 minutes. The product, which left the static mixer at the end of the reaction zone at a temperature of approximately 140° C., was conveyed onto metal sheets for cooling. A pale yellow solid was obtained which had the following properties:

| | |
|---|---|
| NCO content: | 0.4% |
| uretdione group content (calc.): | 13.6% |
| melting point: | 98-100° C. |
| glass transition temperature: | 58° C. |
| viscosity (130° C.): | approx. 520 Pa · s |

### Example 2 (Comparison)

1000 g (4.1 eq.) of the uretdione group-containing polyisocyanate from Example 1 (receiver A) were heated to 80° C. in a stirring apparatus under dry nitrogen. Over a period of 30 mins, 493 g (4.1 eq.) of the catalyzed polyol mixture described in Example 1 (receiver B) were then added with stirring. As early as during the dropwise addition, the heating bath temperature had to be raised to 120° C. due to the rapidly increasing viscosity of the mixture, in order further to ensure stirrability. After 45 mins, the NCO content of the then highly viscous reaction mixture amounted to 1.8% and the heating bath temperature had to be increased to 130° C. After 60 minutes, the NCO content had increased to 3.5%.

The comparative example showed that the uretdione group-containing polyaddition product obtained by the process according to the invention described in Example 1 cannot be produced with a low residual NCO content by a discontinuous vessel process due to its high melt viscosity. After a longer residence time in the reactor, uretdione cleavage occurred to a considerable extent, causing the formation of isocyanate groups.

### Example 3

A uretdione group-containing polyaddition compound was produced by the process described in Example 1 and in the apparatus described therein. 1230 g (5.1 eq.) per hour of the IPDI uretdione described in Example 1 and preheated to 80° C. were metered from receiver A to the mixing zone and at the same time 570 g (5.1 eq.) of a polyol mixture, containing 60.0 parts by weight of a polyester diol prepared from adipic acid and 1,4 butane diol and having an OH value of 120 mg KOH/g, 31.3 parts by weight 1,4 butanediol, 8.5 parts by weight 2-ethyl-1-hexanol and 0.2 parts by weight DBTL were metered in from receiver B.

The static mixer was heated as in Example 1; the average residence time of the reaction melt amounted to approximately 6 mins. A virtually colorless solid was obtained with the following properties:

| | |
|---|---|
| NCO content: | 0.6% |
| uretdione group content (calc.): | 13.8% |
| melting point: | 84-87° C. |
| glass transition temperature: | 61° C. |
| viscosity (130° C.): | approx. 500 Pa · s |

### Example 4

A uretdione group-containing polyaddition compound was produced by the process described in Example 1 and in the apparatus described therein. 1815 g (7.8 eq.) of a polyisocyanate mixture, preheated to 80° C. and containing 79.7 parts by weight of the IPDI-based, uretdione group-containing polyisocyanate described in Example 1 and 20.3 parts by weight of a uretdione and isocyanurate group-containing polyisocyanate (prepared from 1,6-diisocyanatohexane (HDI) and having a free isocyanate group content of 20.6%, an average NCO functionality of 2.3 and a uretdione group content determined by hot titration of 15.0%) were metered per hour from receiver A to the mixing zone. At the same time 885 g (7.8 eq.) of a polyol mixture, containing 59.2 parts by weight of a polyester diol prepared from adipic acid and neopentyl glycol and having an OH value of 224 mg KOH.g, 23.0 parts by weight 1,4 butanediol, 17.6 parts by weight 2-ethyl-1-hexanol and 0.2 parts by weight DBTL were metered in from receiver B.

The static mixer was heated as in Example 1; the average residence time of the reaction melt amounted to approximately 4 minutes. A virtually colorless solid was obtained with the following properties:

| | |
|---|---|
| NCO content: | 0.4% |
| uretdione group content (calc.): | 13.6% |
| melting point: | 93-96° C. |
| glass transition temperature: | 50° C. |
| viscosity (130° C.): | approx. 460 Pa · s |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing uretdione group-containing polyaddition products, which are solid below 40° C. and liquid above 125° C., which comprises reacting in a static mixer
A) a uretdione group-containing polyisocyanates with an average isocyanate functionality of at least 2.0, and
B) up to 70 wt. %, based on the total weight of components A) and B), of a diisocyanate other than A), with
C) a polyol having a number average molecular weight of 62-2000 and an average functionality of at least 2.0, and
D) up to 40 wt. %, based on the total weight of components C) and D), of a monofunctional isocyanate-reactive compound,
at an equivalent ratio of isocyanate groups to isocyanate reactive groups of 1.8:1 to 0.6:1.

2. The process according to claim 1 wherein uretdione group-containing polyisocyanate A) is prepared from a diisocyanate which has aliphatically and/or cycloaliphatically bound isocyanate groups.

3. The process according to claim 1 wherein uretdione group-containing polyisocyanate A) is prepared from 1,6-diisocyanatohexane and/or 1-isocyanato-3,3,5-trimethyl-5-isocyanatomethylcyclohexane.

4. The process according to claim 1 wherein polyol C) comprises a polyhydric alcohol having a molecular weight of 62 to 400, and/or a polyester or polycarbonate polyol.

5. The process according to claim 1 wherein the polyol C) comprises a diol having a molecular weight of 62 to 300, and/or a polyester or polycarbonate diol having molecular weights of 134 to 1200.

6. The process according to claim 1 wherein polyol C) is a mixture of
0 to 100 wt. %, (based on the weight of polyol C), of a polyester diol having a molecular weight of 134 to 1200, and
0 to 80 wt. %, (based on the weight of polyol C), of a diol having a molecular weight of 62 to 300.

7. A process for producing uretdione group-containing polyaddition products, which are solid below 40° C. and liquid above 125° C., which comprises reacting in a static mixer
A) a uretdione group-containing polyisocyanates with an average isocyanate functionality of at least 2.0, and
B) up to 70 wt. %, based on the total weight of components A) and B), of a diisocyanate other than A), with
C) a polyol having a number average molecular weight of 62-2000 and an average functionality of at least 2.0, and
D) up to 40 wt. %, based on the total weight of components C) and D), of a monofunctional isocyanate-reactive compound,
at an equivalent ratio of isocyanate groups to isocyanates-reactive groups of 1.8:1 to 0.6:1 wherein the static mixer contains least one mixing zone and a subsequent reaction zone.

8. The process according to claim 7 wherein uretdione group-containing polyisocyanate A) is prepared from a diisocyanate which has aliphatically and/or cycloaliphatically bound isocyanate groups.

9. The process according to claim 7 wherein uretdione group-containing polyisocyanate A) is prepared from 1,6-diisocyanatohexane and/or 1-isocyanato-3,3,5-trimethyl-5-isocyanatomethylcyclohexane.

10. The process according to claim 7 wherein polyol C) comprises a polyhydric alcohol having a molecular weight of 62 to 400, and/or polyester or polycarbonate polyol.

11. The process according to claim 7 wherein the polyol C) comprises a diol having a molecular weight of 62 to 300, and/or a polyester or polycarbonate diol having molecular weights of 134 to 1200.

12. The process according to claim 7 wherein the polyol C) is a mixture of
20 to 100 wt. %, (based on the weight of polyol C), of a polyester diol having a molecular weight of 134 to 1200, and
0 to 80 wt. %, (based on the weight of polyol C), of a diol having a molecular weight of 62 to 300.

13. The process according to claim 7 wherein the static mixer contains at least one zone, the temperature of which may be separately controlled.

14. The process according to claim 7 wherein the static mixer contains a mixing zone heated to a temperature of up 140° C. and a subsequent reaction zone heated to a temperature of 60 to 180° C.
